(19) United States
(12) Patent Application Publication
(10) Pub. No.: US 2004/0107923 A1
(43) Pub. Date: Jun. 10, 2004

(54) Rotating cylinder valve engine

(76) Inventor: Keith Trevor Lawes, Pooles Dorset (GB)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/468,932

(22) PCT Filed: Mar. 7, 2002
(86) PCT No.: PCT/GB02/01049

(30) Foreign Application Priority Data
Mar. 7, 2001 (GB) 0105570.6

(51) Int. Cl. F02B 57/00

(52) U.S. Cl. 123/45 A; 123/43 R

(57) ABSTRACT

A rotating cylinder valve engine (1) comprises an engine casing comprising two casing sections (2, 4) and a double piston and rotating cylinder assembly (5). The casing section (2) is formed with an internal chamber (6) that extends from a open-end of circular cross-section towards a closed-end of the casing section (2). Extending radially outward from the open-end of the casing section (2) is a substantially circular flange (8). The flange (8) comprises four lobe portions (10) each formed with a bolt hole. The flange (8) is formed with a circular radially inner recess (9). The casing section (2) is formed with a fuel inlet port 3a, port for a spark plug (3b) and an exhaust port (3c).

The present invention relates to a rotatable cylinder valve engine and is concerned particularly, although not exclusively, with camming means and a cam follower bearing assembly for a rotatable cylinder valve engine and a piston for a rotatable cylinder valve engine.

For known engines which comprise a rotating cylinder wall and a reciprocating piston the linear motion of the reciprocating piston is converted into the rotation of the cylinder wall. The rotation of the wall is utilised for the opening and closing of fuel inlet and exhaust outlet ports of the engine. An example of a rotating cylinder valve engine is described in the specification of PCT patent application no. PCT/GB97/01934 in the name of RCV Engines Limited. The specification describes how the linear motion of the reciprocating piston is converted into the rotation of the cylinder wall by the use of a pair of bevel gears.

According to a first aspect of the present invention there is provided camming means for a rotatable cylinder valve engine comprising bearing means, piston means being disposed within a rotatable cylinder, and an engine casing comprising two portions, the camming means comprising a curved cam channel defined by two curved cam surfaces, each cam surface being formed on a portion of the engine casing, the arrangement being such that, in use, the reciprocating action of the piston means is converted into a rotational action of the cylinder by the bearing means travelling along the cam channel.

In an embodiment of the present invention the piston means comprises a piston formed with a piston head portion and two limb portions each extending in a direction substantially parallel to the axis of the piston, the arrangement being such that diameter of the piston head portion is less than the distance between the respective outer radial surfaces of each limb portion.

Preferably, the piston means comprises two pistons and the rotatable cylinder comprises two combustion chambers, each combustion chamber being formed with a closed end and an open end, the arrangement being such that in use a piston reciprocates within each combustion chamber.

The rotatable cylinder is preferably formed with a number of access slots through which the bearing means extends.

The bearing means preferably comprises two pairs of bearing assemblies, a pair of bearing assemblies being attached to each piston.

Preferably, each bearing assembly comprises two roller bearings, the arrangement being such that in use one roller bearing of a bearing assembly travels along one of the cam surfaces formed on a first portion of the engine casing and a second roller bearing of the bearing assembly travels along a cam surface formed on a second portion of the engine casing.

The two roller bearings of a bearing assembly are preferably not coaxial.

The respective axis of rotation of the two roller bearings of a bearing assembly are preferably substantially parallel.

The respective axis of rotation of the two roller bearings of a bearing assembly are preferably disposed between the two cam surfaces of the cam channel.

In an alternative embodiment of the present invention the two roller bearings of a bearing assembly are coaxial and the cam channel comprises two curved cam tracks each formed by two offset curved groove surfaces.

We have discovered that a particular problem may occur when using roller bearings on a cam surface. The radially outer portion of the roller bearing is prone to skidding due to the circular nature of the cam surface, which the roller bearing must follow.

In an embodiment of the present invention the two roller bearings of the bearing assembly are preferably arranged such that the rotation of a first roller bearing in one rotational direction causes a counter-rotation of a second roller bearing in an opposite rotational direction.

Preferably, the bearing assembly comprises gearing means for the two roller bearings the arrangement being such that in use the gearing means produces a counter-rotation of a second roller bearing in an opposite rotational direction to the rotation of a first roller bearing.

In a further embodiment of the present invention the bearing assembly preferably comprises means to force a first roller bearing of the bearing assembly in a direction away from a second roller bearing of the bearing assembly, the arrangement being such that each roller bearing of the bearing assembly is urged towards a respective contact surface of the cam channel.

Preferably, the roller bearings are a cylindrical shape.

Alternatively in a further embodiment of the present invention the roller bearings are preferably a conical shape, the arrangement being such in use that greater diameter of a roller bearing travels around the radially outermost portion of a cam track and the smaller diameter of a roller bearing travels around the radially innermost portion of a cam track.

The two combustion chambers of the rotatable cylinder are preferably separable from each other when the engine is disassembled.

Each combustion chamber preferably comprises a plurality of limbs that each extend from the wall of the open end of the combustion chamber in a direction away from the closed end, the arrangement being such that when the engine is in an assembled state the respective limbs of the combustion chambers define the access slots through which the bearing means extends.

Preferably, in the assembled state the limbs of the respective combustion chambers interlock with each other.

In a preferred embodiment of the present invention each piston is formed with two traveller portions each slidably disposed between two limbs that each form an access slot of a combustion chamber, the arrangement being such that in use each traveller portion is in slidable contact with longitudinal surfaces of two of the limbs of the combustion chamber and the traveller portion reciprocates longitudinally within the access slot.

Preferably, the traveller portions of the piston and the limbs are each formed with corresponding radial contact surfaces.

The traveller portions are preferably each a truncated wedge shape.

Preferably, the contact surfaces of each traveller portion extend radially beyond the cross sectional diameter of the piston head.

The two traveller portions of each piston are preferably each formed on a leg that extends longitudinally from the piston head.

Each piston is preferably formed with a piston head and a pair of leg portions each extending from a lower region of the piston head, a traveller portion being formed on each leg portion.

Each traveller portion preferably extends longitudinally in a direction substantially parallel to the axis of the piston, along the substantial length of the respective leg portion.

Preferably, each traveller portion is formed with fillet surface extending from a radially outermost edge of the traveller portion towards the piston head.

In an alternative embodiment of the present invention each bearing assembly preferably comprises a slidable traveller disposed between two limbs within an access slot of a combustion chamber, the arrangement being such that in use each traveller is in slidable contact with longitudinal surfaces of two of the limbs of the combustion chamber and the traveller reciprocates longitudinally within the access slot.

Preferably, the travellers and the limbs are each formed with corresponding radially extending contact surfaces.

The travellers are preferably each a substantially truncated wedge shape.

According to a second aspect of the present invention there is provided a rotatable cylinder valve engine comprising, camming means, piston means being disposed within a rotatable cylinder and the cylinder being disposed in an engine casing, and bearing means; the camming means comprising a curved cam channel formed on a portion of the engine casing; the piston means comprising a piston formed with a piston head portion and two limb portions and each limb portion extends in a direction substantially parallel to the axis of the piston, the diameter of the piston head portion being less than the distance between the respective outer radial surfaces of each limb portion, the arrangement being such that in use the reciprocating action of the piston is converted into a rotational action of the cylinder by the bearing means travelling along the cam channel.

There are particular advantages to combining the features of the various aspects of the present invention and the invention may include any combination of the features or limitations referred to herein.

The present invention may be carried into practice in various ways and some embodiments will now be described, by way of example only, with reference to the accompanying drawings in which:

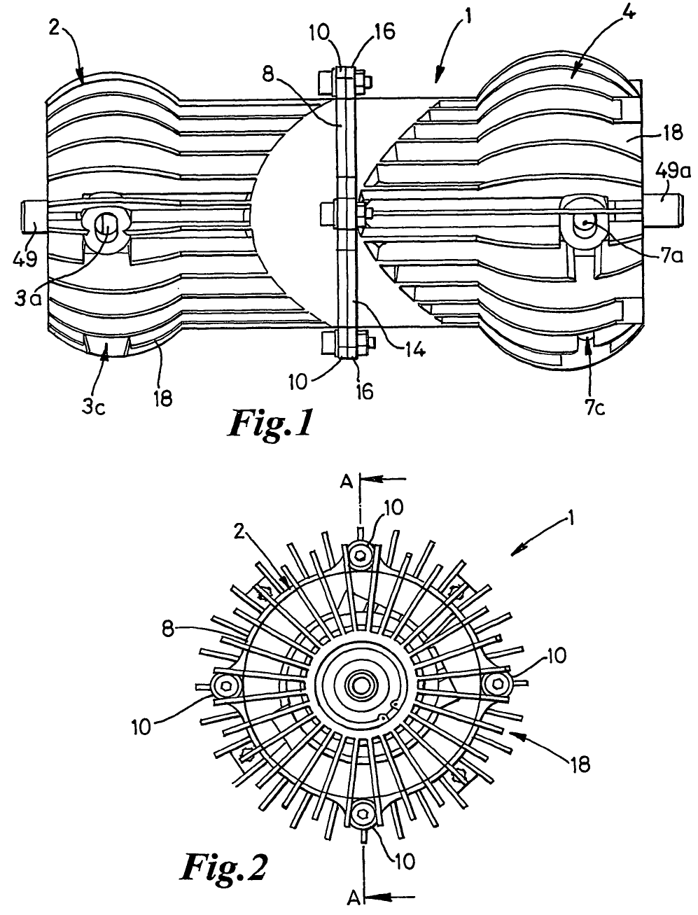

FIG. 1 is a side view of a rotatable cylinder valve engine;

FIG. 2 is an end view of the rotatable cylinder valve engine shown in FIG. 1;

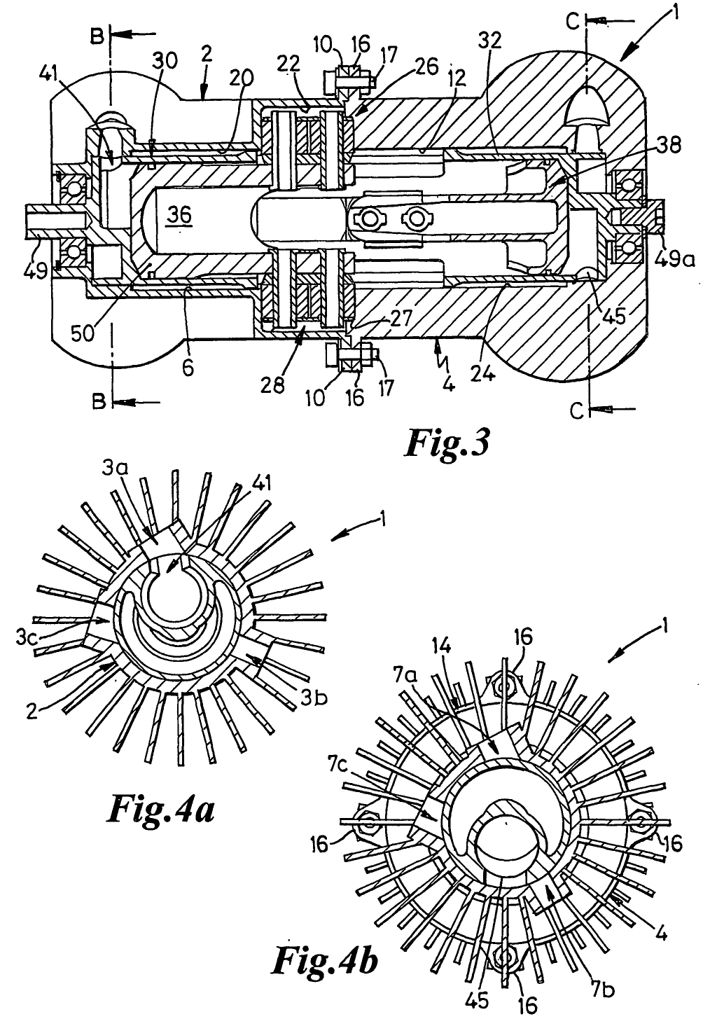

FIG. 3 is a view of cross section through AA of the end view of the rotating cylinder valve engine shown in FIGS. 1 and 2;

FIG. 4a is a view of cross section through BB of the rotating cylinder valve engine shown in FIG. 3;

FIG. 4b is a view of cross section view through CC of the rotating cylinder valve engine shown in FIG. 3;

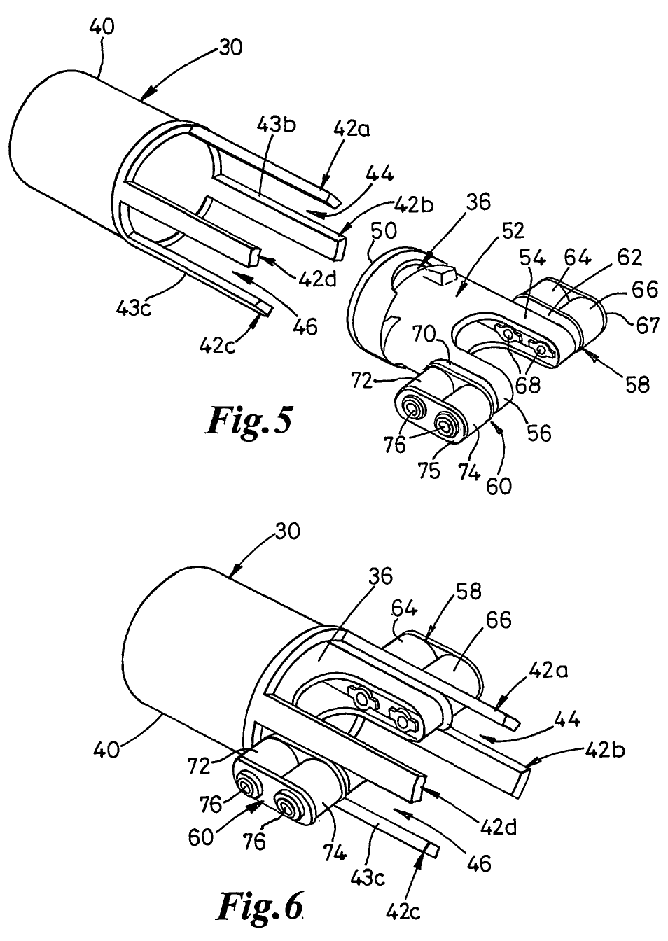

FIGS. 5 to 10 are isometric views of the assembly of various components of the rotating cylinder valve engine shown in FIGS. 1 to 4b;

FIG. 11 is a side elevation of an embodiment of a piston for a rotatable rotatable cylinder valve engine;

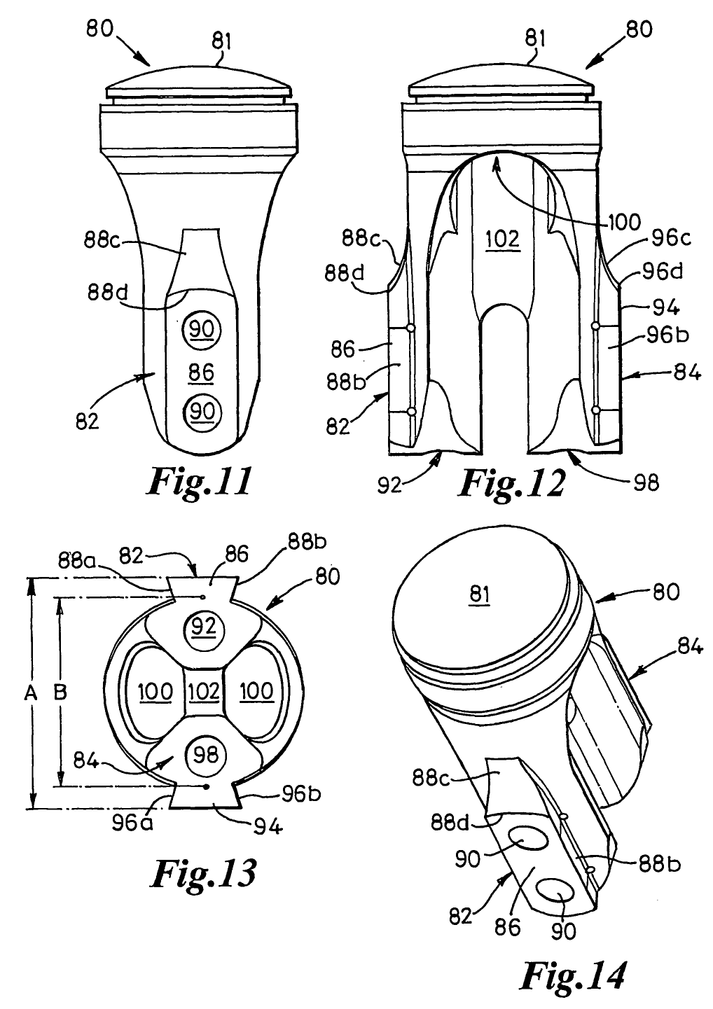

FIG. 12 is a front elevation of the piston shown in FIG. 11;

FIG. 13 is a base view of the piston shown in FIGS. 11 and 12;

FIG. 14 is a isometric view of the piston shown in FIGS. 11 to 13;

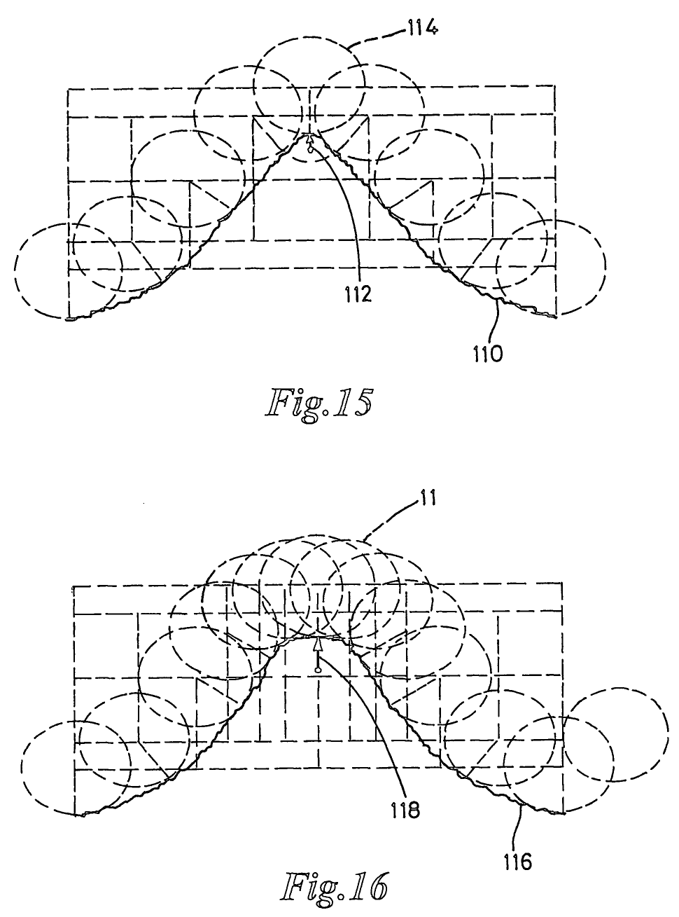

FIG. 15 is a profile of a sinusoidal cam surface and a trace of a path of a roller bearing; and

FIG. 16 is a profile of a modified cam surface and a trace of a path of a roller bearing.

The main principles of the operation of a rotating cylinder valve engine is substantially described in the specification of the international patent application no PCT/GB97/01934 in the name of RCV Engines Limited. The specification of this application describes a rotating cylinder valve engine used for a model aircraft. The reciprocating motion of a piston is converted into a rotating motion of a cylinder. The rotating cylinder and engine housing co-operate to provide a fuel inlet valve, an exhaust outlet valve and the indexing of ignition means. The rotating cylinder also provides the power output of the engine to the propeller. The skilled person in the art will appreciate that the power output means may be provided by the crankshaft assembly instead of, or as well as, the rotating cylinder.

With reference to the Figures, a rotating cylinder valve engine 1 comprises an engine casing comprising two casing sections 2, 4 and a double piston and rotating cylinder assembly 5.

The casing section 2 is formed with an internal chamber 6 that extends from a open-end of circular cross-section towards a closed-end of the casing section 2. Extending radially outward from the open-end of the casing section 2 is a substantially circular flange 8. The flange 8 comprises four lobe portions 10 each formed with a bolt hole. The flange 8 is formed with a circular radially inner recess 9. The casing section 2 is formed with a fuel inlet port 3a, port for a spark plug 3b and an exhaust port 3c.

The casing section 4 is also formed with an internal chamber 12 that extends from an open-end of circular cross-section. Extending radially outward from the open end of the section 4 is a substantially circular flange 14. The flange 14 comprises four lobe portions 16 each formed with a bolt hole that align with the bolt holes in the lobe portions 10. The flange 14 is formed with a with an axially outwardly protruding circular rim adapted to be received by the radially inner recess 9 of the flange 8. The casing section 4 is also formed with a fuel inlet port 7a, a port for a spark plug 7b and an exhaust port 7c.

The internal chamber 6 and the internal chamber 12 are adapted to receive respective portions of the double piston and rotating cylinder assembly 5.

Each of the casing sections 2, 4 comprises an array of cooling fins 18 that extend radially outwardly therefrom. The casing sections 2, 4 are adapted to fit together by placing the outwardly protruding circular rim of the flange 14 into the radially inner recess 9 of the flange 8 and aligning the respective bolt holes. The casing sections 2, 4 are held together by four pairs of nuts and bolts 17.

The internal chamber 6 of the casing section 2 comprises a cylindrical cylinder portion 20 and a camming portion 22. The camming portion 22 comprises a curved cam surface 25 that extends around the inner circumference of the casing 2. The internal chamber 12 of the casing section 4 comprises a cylinder portion 24 and a corresponding camming portion 26 comprising a curved cam surface 27 that extends around the inner circumference of the casing 4. In the assembled state the camming portions 22, 26 form a curved camming channel 28 partially defined by the two camming surfaces 25, 27.

The double piston and rotating cylinder assembly 5 comprises two rotatable cylinders 30, 32 and two pistons 36, 38.

The rotatable cylinder 30 comprises a cylindrical cylinder portion 40 and four limbs 42a, 42b, 42c, 42d that each extend from the edge of the open-end of the cylinder 30 in a direction substantially parallel to the central axis of the cylinder 30. Each limb 42a, 42b, 42c, 42d comprises two parallel radially extending side faces, a radially outermost surface, a radially innermost surface and a distal end surface. A first side surface (hidden in the Figures) of limb 42a and an opposing first side surface 43b of limb 42b form a first slide bearing channel 44. A first side surface (hidden in the Figures) of limb 42d and an opposing first side surface 43c of limb 42c form a second slide bearing channel 46. The closed-end of the cylinder 30 is formed with a power output shaft 49. The shaft 49 extends in a coaxial direction through the casing 2.

The piston 36 comprises a piston head portion 50, a substantially hollow body portion 52 and two leg portions 54, 56. Attached to leg portion 54 is a bearing assembly 58 and a bearing assembly 60 is attached to the leg portion 56. The bearing assembly 58 comprises a slider 62, two roller bearings 64, 66 and an end plate 67. The bearing assembly 58 is attached to the leg portion 54 by two rivets 68. Bearing assembly 60 also comprises a slider 70, two roller bearings 72, 74 and an end plate 75. The bearing assembly 60 is attached to the leg portion 56 using two rivets 76. The two sliders 62, 70 are each a truncated wedge shape and each are formed with longitudinal side faces that extend in a direction radially outwards. The side faces of the sliders 62, 70 are adapted to slide against the respective side faces of the limbs 42a, 42b, 42c, 42d.

An alternative and preferred piston and slide bearing arrangement is shown in FIGS. 11 to 14. The piston 80 is formed with a head portion 81 and two integral hollow leg portions 82, 84. Extending radially outwardly from the leg portion 82 there is a traveller bearing portion 86. The traveller bearing portion 86 is formed with two sloping side faces 88a, 88b and a fillet surface 88c that extends from a radially outermost upper edge 88d to the leg portion 82 in a direction towards the head portion 81. The faces 88a, 88b are adapted to correspond with the two parallel radially extending side faces of the limbs 42a, 42b, 42c, 42d as previously described. The fillet surface 88c strengthens the intersection between the traveller bearing portion 86 and the leg portion 82 by lessening the stress concentration. Two holes 90 of circular cross-section extend radially through the body of the leg portion 82. In the assembled state the rivets 76 that attach the roller bearings to the slide bearing portion extend through the holes 90. A channel 92 of circular cross-section extends longitudinally through the leg portion 82 in a direction from the distal end face of the leg portion 82 substantially parallel to the axis of the piston 80.

Extending radially from the leg portion 84 there is a traveller bearing portion 94. The traveller bearing portion 94 is formed with two sloping side faces 96a, 96b and a fillet surface 96c that extends from a radially outermost upper edge 96d to the leg portion 84 in a direction towards the head portion 81. The faces 96a, 96b are adapted to correspond to the two parallel radially extending side faces of the limbs as previously described. Two holes (not shown) of circular cross-section extend through the body of leg portion 82 similar to holes 90. A channel 98 of circular cross-section extends longitudinally through the leg portion 84 in a direction from the distal end face of the leg portion 84 substantially parallel to the axis of the piston 80.

The distance of a diameter ‘A’ between the respective radially outer faces of the leg portions 82, 84 is greater than a diameter ‘B’ of the piston head portion 81. The greater diameter ‘A’ provides a significant advantage due to the increased strength of the leg portions 82, 84. In use there are relatively large forces transferred through the leg portions 82, 84 and the increased diameter of the leg portions 82, 84 helps to significantly reduce any deflection of the legs portions 82, 84. Any such deflection will adversely affect the life of the bearings and the other engine components.

The piston head portion 81 is formed with two hollowed out recesses 100, which are separated by a central web 102 that extends between the upper parts of the leg portions 82, 84.

The cylinder portion 30 is formed with a port 41 that extends in a radial direction through the wall of the cylinder 30 and the cylinder portion 32 is formed with a port 45 that extends in a radial direction through the wall of the cylinder 32.

The rotatable cylinder 32 and piston 38 both comprise features that correspond to those described for cylinder 30 and piston 36.

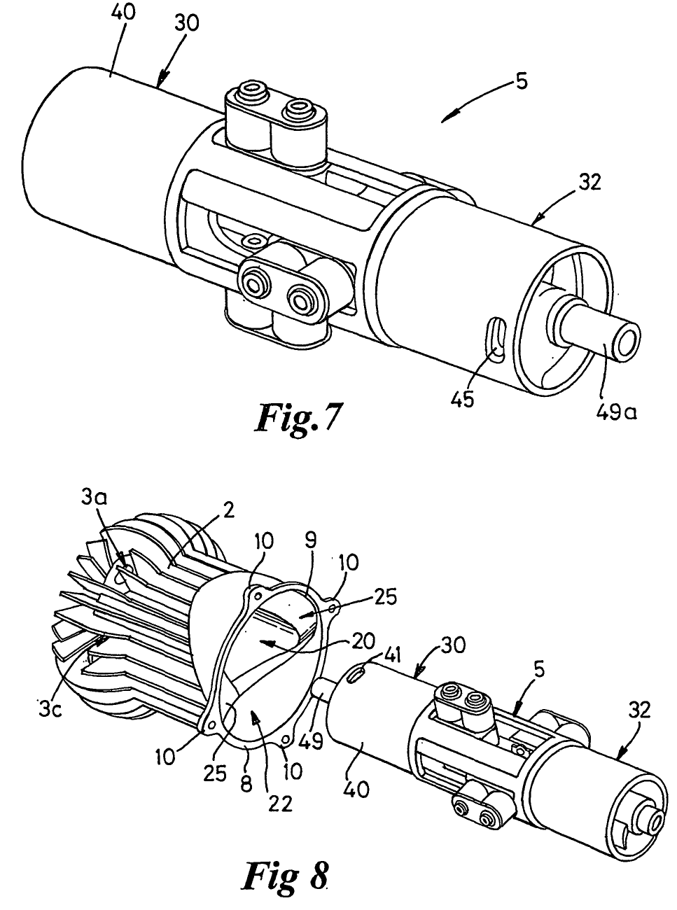

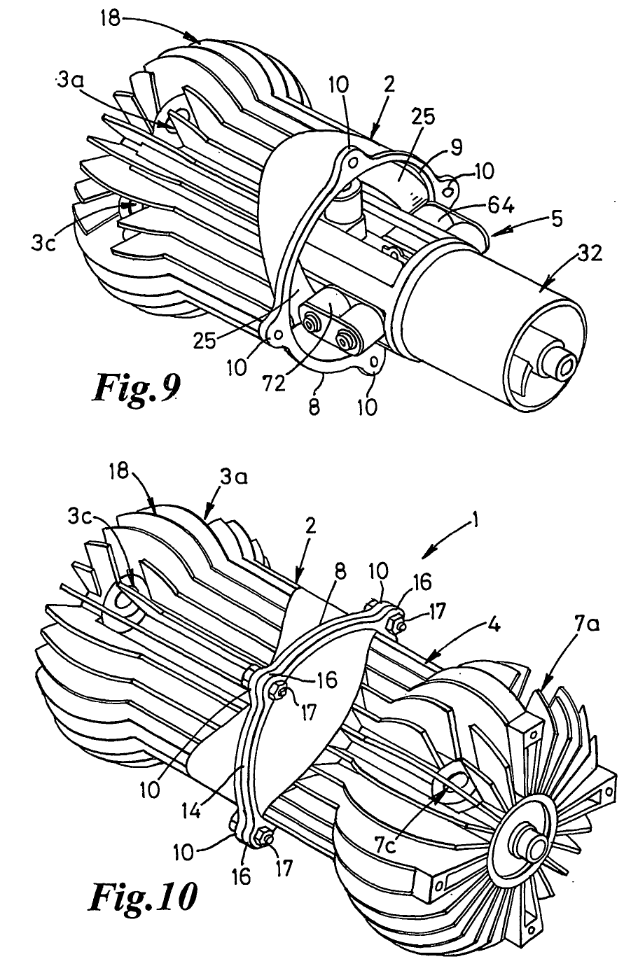

With reference to FIGS. 7 to 9, the respective limbs of the two rotatable cylinders 30, 32 are interlocked. The respective bearing assemblies of each cylinder are disposed at right angles to each other. The cylinder portion 40 of the rotatable cylinder 30 is received by the casing section 2 (as shown in FIG. 9). The roller bearing 72 and roller bearing 64 are in rollable contact with the cam surface 25. The corresponding roller bearings of the piston assembly 38 are in rollable contact with the cam surface 25. When the casing section 4 is placed over the rotatable cylinder 32 the other roller bearings will come into rollable contact with the corresponding cam surface of the casing section 4.

In use the reciprocating motion of the two pistons 36, 38 is converted into a rotational motion of the cylinder assembly 5 by the action of the bearing assemblies travelling over the respective cam tracks. The rotational motion of the cylinder assembly 5 indexes the ports 45, 47 with the respective inlet ports 3a, 7a, the spark plug and then the exhaust ports 3c, 7c. The power of the engine is utilised by using rotational motion of the output shaft 49 of the of the cylinder assembly 5. The corresponding output shaft 49a of the cylinder 32 may also be used as a power transfer means.

There follows a discussion of some experimental results of an embodiment of the present invention.

Initial calculations indicate that the life of each bearing assembly running along the cam surface 25 and corresponding cam surface of the casing section 4 should be satisfactory. However there are several effects that may reduce the life from this calculated value. These are cam surface radii, differential skidding of the roller bearings and loss of cam surface contact skidding.

1. Tight Cam Surface Radii.

A needle roller bearing assembly was used, which rotated around an inner race that had a comparatively large radius of around 14 mm. The effective radius of the substantially sinusoidal curved camming channel 28 at the peak of the stroke (at the point where the bearing is subject to maximum compression load) is much smaller than this. This will reduce the effective contact area of the needle roller bearing on the cam surface and thus reduce the life of the needle roller bearing. FIG. 15 shows a typical sinusoidal profile 110 of a sinusoidal cam surface. The inner radius 112 is approximately 1.8 mm. The snap shot trace 114 shows the path made by a needle roller bearing travelling over the sinusoidal cam surface.

The sharpness on the peak of the cam surface will increase with the increasing outer diameter of the needle roller bearing, increasing stroke and decreasing the diameter of the camming channel 28. FIG. 15 shows a worst case profile 112 for the 35×26 bore/stroke engine running with 14 mm outer diameter bearings around a cam surface with the minimum possible diameter of 40 mm i.e. the inside of the bearing cam surface. As can be seen the peak of the cam profile 112 is very sharp, having a radius of around 1.8 mm. On the outside of the cam surface this radius is much greater. However this small peak on the inside could cause wear problems.

To improve the situation it is possible to deviate the shape of the cam surface from a pure sinusoid. The profile 116 shown in FIG. 16 uses a circular profile at the cam surface peaks. This increases to an inner peak radius 118 to around 7 mm. This should ensure the needle roller bearing outer life will not be significantly affected by the reduced radius. If, following experimentation, it is found that the radius needs to be increased still further the two main parameters that can be changed are the engine's bore stroke ratio (reducing the stroke will increase this radius) and the cam surface diameter (increasing the cam surface diameter will increase this radius).

2. Differential Skidding

Because the outermost portion of the needle roller bearing is running around a circular cam surface, the radially outermost edge of the roller travels further than its radially innermost edge. If the needle roller bearing is cylindrical this means there must be some differential skidding between the roller bearing and the cam surface. The effective slip speed of this differential skidding is fairly low, but its effect on needle roller bearing life is very difficult to predict. The differential skidding can be very considerably reduced by using a conical outer case on the needle roller bearing. This conical case would have a larger diameter on the radially outermost edge of the bearing compared to the radially innermost edge, similar in profile to a bevel gear. The angle of the cone would be selected so that the outside and inside edges of the needle roller bearing outer would rotate the same number of times for a single “journey” around the cam surface. The sinusoidal cam surface would then be machined with a tool with the same conical profile which would then accept the conical needle roller bearing outer. This configuration would only completely eliminate differential skidding for a flat circular cam surface. In areas of the cam surface where there is a gradient there would still be residual differential skidding between the inside and outside edges of the needle roller outer. This is because for movement of the roller parallel to the axis of rotation the actual distance travelled by the inside and outside edges of the roller is the same. This can best be illustrated by imagining a section of cam surface which is vertical i.e. moving the piston up or down the bore without rotating the cylinder. Although the conical needle roller outer must suffer some residual differential skidding because of this affect, it will be of much smaller magnitude than the differential skidding of a cylindrical roller.

3. Loss of Cam Surface Contact Skidding

In a bearing assembly it is important that the rollers stay in constant contact with the bearing cam surface. As a roller rotates around a bearing, a load is applied to the roller when it is on the same side of the bearing as the applied force vector, and removed from the roller when it is on the opposite side of the bearing to the applied force vector. If the bearing internal clearances are too great, when the load is removed from the roller the roller will loose contact with a track and slow down. Then when the roller moves around to the force vector side of the bearing and contact is re-established between the roller and camming channel, skidding will occur whilst the roller is accelerated up to speed. This can cause very rapid wear.

The needle roller outer and a sinusoidal camming channel suffer from the same potential problem in that there is at least one force reversal on the bearing as the engine goes through the four stroke cycle. At slower engine speeds and higher throttle openings there is only one force reversal. Under these circumstances compression force is the dominant force, and from the second half of the inlet stroke, through the compression and power strokes, and through the first half of the exhaust stroke the load will be taken by the bottom bearing. The force reversal occurs around halfway through the exhaust stroke, when the top bearing starts to take the load as it decelerates the piston to a halt and then accelerates it back down the bore. The load reverts back to the bottom bearing halfway down the inlet stroke.

At low throttle openings and high RPM, when the forces required to accelerate the piston becomes greater than the compression pressure force, it is possible in some circumstances for force reversals to occur on the compression and power strokes. In general the higher the RPM, the lower the inlet charge pressure and the greater the piston weight the greater the chances of a force reversal occurring during the compression and power strokes.

During the periods when one of the pair of needle roller bearings on each piston leg is not taking the load it must be kept running at the correct rotational speed so that when the force reversal occurs and a load is applied to the bearing there is no skidding between the needle roller outer and the camming channel. The most obvious way to accomplish this is to ensure that the gap between the top cam surface and bottom cam surface of the camming channel is very precisely toleranced so that the radially outermost portion of the bearing cannot loose contact with the camming channel when the force is not applied to them.

Possibly a suitable lubricant with slightly adhesive properties e.g. castor oil, may improve the situation by causing the radially outermost portion of the needle roller to stick to the camming channel. It may be desirable to spring the two needle rollers apart slightly so that the unloaded bearing is forced against its camming channel with a light contact force sufficient to keep it turning.

Another desirable method of coping with this problem may be to effectively gear the two bearings together. This could be done by simply mounting the two needle roller bearings close together on the piston leg so that their outer surfaces touch. The bearing to which the load was applied would then rotate the unloaded bearing in the opposite direction at the same speed. When the load reversal occurred the unloaded bearing would be running at the correct speed. If the bearings were geared together and running at the same speed, at top dead centre and bottom dead centre the unloaded bearing outer would be effectively skidding relative to the cam surface of the camming channel. This could be coped with by increasing the gap between the two cam surfaces of the camming channel at top dead centre and bottom dead centre so that the unloaded bearing was not in contact with the respective cam surface of the camming channel.

As described above for higher throttle openings and lower RPM only one force reversal will occur. This will happen around the halfway point of the exhaust and inlet strokes. At this point the bearing speeds of the top and bottom needle rollers in their free running state would be very similar, hence gearing the bearings together would produce benefit in that the unloaded bearing would be rotating at the correct speed when the force reversal occurs. At lower throttle openings and higher RPM, where force reversals occur at points where the bearing outer speeds are different, it is hard to predict how the geared together bearings would behave.

1. Camming means for a rotatable cylinder valve engine (1) comprising bearing means, piston means (40, 50) being disposed within a rotatable cylinder (30, 32), and an engine casing comprising two portions (2, 4), the camming means comprising a curved cam channel (28) defined by two curved cam surfaces (25, 27), each cam surface being formed on a portion of the engine casing, the arrangement being such that, in use, the reciprocating action of the piston means (40 50) is converted into a rotational action of the cylinder (30, 32) by the bearing means travelling along the cam channel (28).

2. Camming means for a rotatable cylinder valve engine as claimed in claim 1, wherein the piston means comprises a piston (80) formed with a piston head portion (81) and two limb portions (82, 84) each extending in a direction substantially parallel to the axis of the piston, the arrangement being such that diameter of the piston head portion (81) is less than the distance between respective outer radial surfaces (86, 84) of each limb portion (82, 84).

3. Camming means for a rotatable cylinder valve engine as claimed in claim 1 or claim 2, wherein the piston means comprises two pistons (36, 38) and the rotatable cylinder comprises two combustion chambers (30, 32), each combustion chamber (30, 32) being formed with a closed end and an open end, the arrangement being such that in use a piston (36, 38) reciprocates within each combustion chamber (30, 32).

4. Camming means for a rotatable cylinder valve engine as claimed in any one of claims 1 to 3, wherein the rotatable cylinder is formed with a number of access slots through which the bearing means extends.

5. Camming means for a rotatable cylinder valve engine as claimed in claim 3 or claim 4, wherein the bearing means comprises two pairs of bearing assemblies (58, 60), a pair of bearing assemblies (58, 60) being attached to each piston (36, 38).

6. Camming means for a rotatable cylinder valve engine as claimed in claim 5, wherein each bearing assembly (58, 60) comprises two roller bearings (64, 66, 72, 74), the arrangement being such that in use one roller bearing of a bearing assembly (58, 60) travels along one of the cam surfaces (25, 27) formed on a first portion of the engine casing and a second roller bearing of the bearing assembly (58, 60) travels along a cam surface (25, 27) formed on a second portion of the engine casing.

7. Camming means for a rotatable cylinder valve engine as claimed in claim 6, wherein the two roller bearings of a bearing assembly are not coaxial.

8. Camming means for a rotatable cylinder valve engine as claimed in claim 7, wherein the respective axis of rotation of the two roller bearings of a bearing assembly are substantially parallel.

9. Camming means for a rotatable cylinder valve engine as claimed in claim 7 or claim 8, wherein the respective axis of rotation of the two roller bearings of a bearing assembly are preferably disposed between the two cam surfaces of the cam channel.

10. Camming means for a rotatable cylinder valve engine as claimed in claim 6, wherein the two roller bearings of a bearing assembly are coaxial and the cam channel comprises two curved cam tracks each formed by two offset curved groove surfaces.

11. Camming means for a rotatable cylinder valve engine as claimed in any one of claims 6 to 10, wherein the two roller bearings of the bearing assembly are arranged such that the rotation of a first roller bearing in one rotational direction causes a counter-rotation of a second roller bearing in an opposite rotational direction.

12. Camming means for a rotatable cylinder valve engine as claimed in any one of claims 6 to 11, wherein the bearing assembly comprises gearing means for the two roller bearings the arrangement being such that in use the gearing means produces a counter-rotation of a second roller bearing in an opposite rotational direction to the rotation of a first roller bearing.

13. Camming means for a rotatable cylinder valve engine as claimed in any one of claims 6 to 12, wherein the bearing assembly comprises means to force a first roller bearing of the bearing assembly in a direction away from a second roller bearing of the bearing assembly, the arrangement being such that each roller bearing of the bearing assembly is urged towards a respective contact surface of the cam channel.

14. Camming means for a rotatable cylinder valve engine as claimed in any one of claims 6 to 13, wherein the roller bearings are a cylindrical shape.

15. Camming means for a rotatable cylinder valve engine as claimed in any one of claims 6 to 13, wherein the roller bearings are a conical shape, the arrangement being such in use that greater diameter of a roller bearing travels around the radially outermost portion of the cam track (28) and the smaller diameter of a roller bearing travels around the radially innermost portion of a cam track.

16. Camming means for a rotatable cylinder valve engine as claimed in any one of claims 3 to 15, wherein the two combustion chambers (30 32) of the rotatable cylinder are separable from each other when the engine (1) is disassembled.

17. Camming means for a rotatable cylinder valve engine as claimed in claim 16, wherein each combustion chamber (30, 32) comprises a plurality of limbs (42a, 42b, 42c, 42d) that each extend from the wall of the open end of the combustion chamber in a direction away from the closed end, the arrangement being such that when the engine (1) is in an assembled state the respective limbs (42a, 42b, 42c, 42d) of the combustion chambers (30, 32) define the access slots through which the bearing means extends.

18. Camming means for a rotatable cylinder valve engine as claimed in claim 17, wherein in the assembled state the limbs of the respective combustion chambers interlock with each other.

19. Camming means for a rotatable cylinder valve engine as claimed in any one of the preceding claims, wherein each piston is formed with two traveller portions (86, 94) each slidably disposed between two limbs that each form an access slot of a combustion chamber, the arrangement being such that in use each traveller portion (86, 94) is in slidable contact with longitudinal surfaces of two of the limbs of the combustion chamber and the traveller portion reciprocates longitudinally within the access slot.

20. Camming means for a rotatable cylinder valve engine as claimed in claim 19, wherein the traveller portions (86, 94) of the piston and the limbs are each formed with corresponding radial contact surfaces.

21. Camming means for a rotatable cylinder valve engine as claimed in claim 19 or claim 20, wherein the traveller portions (86, 94) are each a truncated wedge shape.

22. Camming means for a rotatable cylinder valve engine as claimed in any one of claims 19 to 21, wherein the contact surfaces of each traveller portion extend radially beyond the cross sectional diameter of the piston head.

23. Camming means for a rotatable cylinder valve engine as claimed in any one of claims 20 to 22, wherein the two traveller portions (86, 94) of each piston are each formed on a leg that extends longitudinally from the piston head.

24. Camming means for a rotatable cylinder valve engine as claimed in any one of claims 20 to 23, wherein each piston is formed with a piston head and a pair of leg portions (82, 84) each extending from a lower region of the piston head, a traveller portion (86, 94) being formed on each leg portion.

25. Camming means for a rotatable cylinder valve engine as claimed in claim 24, wherein each traveller portion extends longitudinally in a direction substantially parallel to the axis of the piston, along the substantial length of the respective leg portion.

26. Camming means for a rotatable cylinder valve engine as claimed in any one of claims 19 to 25, wherein each traveller portion is formed with fillet surface extending from a radially outermost edge of the traveller portion towards the piston head.

27. Camming means for a rotatable cylinder valve engine as claimed in any one of claims 1 to 18, wherein each bearing assembly (58, 60) comprises a slidable traveller (62, 70) disposed between two limbs (42a, 42b, 42c, 42d) within an access slot (44, 46) of a combustion chamber (30), the arrangement being such that in use each traveller (62, 70) is in slidable contact with longitudinal surfaces of two of the limbs of the combustion chamber (30) and the traveller reciprocates longitudinally within the access slot.

28. Camming means for a rotatable cylinder valve engine as claimed in claim 27, wherein the travellers (62, 70) and the limbs are each formed with corresponding radially extending contact surfaces.

29. Camming means for a rotatable cylinder valve engine as claimed in claim 28, wherein the travellers (62, 70) are each a substantially truncated wedge shape.

30. A rotatable cylinder valve engine comprising, camming means, piston means being disposed within a rotatable cylinder and the cylinder being disposed in an engine casing, and bearing means; the camming means comprising a curved cam channel formed on a portion of the engine casing; the piston means comprising a piston formed with a piston head portion and two limb portions and each limb portion extends in a direction substantially parallel to the axis of the piston, the diameter of the piston head portion being less than the distance between the respective outer radial surfaces of each limb portion, the arrangement being such that in use the reciprocating action of the piston is converted into a rotational action of the cylinder by the bearing means travelling along the cam channel.
